(19) United States
(12) Patent Application Publication
(10) Pub. No.: US 2009/0255354 A1
(43) Pub. Date: Oct. 15, 2009

(54) Linear actuating organ, in particular for the remote actuation of displaceable components in wind tunnel models

(75) Inventor: Eldert Akkermann, Bremen (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/991,198

(22) PCT Filed: Aug. 25, 2006
(86) PCT No.: PCT/EP2006/008372

§ 371 Date: Feb. 26, 2008

(30) Foreign Application Priority Data
Aug. 26, 2005 (DE) 10 2005 040 441.3

(51) Int. Cl. F16H 25/20

(52) U.S. Cl. 74/89.33; 74/89.23; 74/89.37

(57) ABSTRACT

A linear actuating element for the remote control of adjustable components on wind tunnel models includes a housing and a gear motor for driving a threaded spindle. On the threaded spindle a threaded nut for moving a pusher rod is arranged. The threaded spindle is connected to the gear motor by a chain drive, wherein the threaded spindle and a gear motor axle are arranged so as to be substantially anti-parallel. Due to the anti-parallel arrangement of the gear motor axle and of the threaded spindle, the linear actuating element on the one hand comprises a compact design. Consequently the linear actuating element is in particular suited to the remote control of adjustable components on wind tunnel models with small spatial dimensions. On the other hand the linear actuating element makes it possible to generate very considerable mechanical actuating forces while at the same time providing very good positioning and repetition accuracy.

The invention relates to a linear actuating element, in particular for the remote control of adjustable components on wind tunnel models, comprising a housing and a gear motor for driving a threaded spindle, wherein on the threaded spindle a threaded nut for moving a pusher rod is arranged.

In wind tunnel models, for example, linear actuators are used for the remote control of adjustable components, in particular of aerodynamically effective areas, valves or the like. Due to the high flow speed of air in the wind tunnel very considerable actuating forces have to be produced by the actuators, wherein at the same time very high positioning and repetition accuracy of the actuators is required in order to obtain measuring results that are as precise as possible. Furthermore, due to the spatially limited size of the wind tunnel models that are commonly used, linear actuators must have a small design size. Moreover, the linear actuators used must make it possible to carry out a large number of actuating tasks without there being any change in the positioning- and repetition accuracy, because the positions of the aerodynamically effective areas of the wind tunnel models have to be continually readjusted during measuring activities.

Known embodiments of linear actuators often do not meet the above-mentioned requirements, or meet these requirements only in an insufficient manner.

It is thus the object of the invention to create a linear actuating element, in particular for the remote control of adjustable components on wind tunnel models, which linear actuating element produces very considerable actuating forces and at the same time produces high positioning- and repetition accuracy, and furthermore has a small design size.

The object according to the invention is met by a linear actuating element with the characteristics of claim 1.

Because the threaded spindle is connected to the gear motor by way of a chain drive, wherein the threaded spindle and a gear motor axle are arranged so as to be essentially anti-parallel, a very small design size of the linear actuating element according to the invention results, wherein at the same time very considerable actuating forces are achievable at high positioning- and repetition accuracy. Moreover, the linear actuating element supports a large number of actuating tasks across the entire travel path without any significant reduction in accuracy. Furthermore, the chain drive makes it possible to decouple the very considerable actuating forces from the forces produced by the gear motor.

According to an advantageous embodiment, the gear motor is eccentrically accommodated for tensioning a chain of the chain drive. This embodiment allows easy tensioning of the chain of the chain drive without there being a need for additional components, for example a chain tensioner or the like.

According to a further advantageous embodiment, the chain of the chain drive can be tensioned by means of at least one chain tensioner. This provides the additional option of tensioning the chain of the chain drive independently of the eccentric bearing arrangement of the gear motor axle in the housing of the linear actuating element.

An advantageous improvement provides for there to be two limit switches for limiting travel of the pusher rod, wherein the limit switches can be actuated by means of a control cam arranged in the region of the pusher rod. In this way damage to the linear actuating element is prevented when the intended travel path of the pusher rod is exceeded.

A further advantageous embodiment provides for each limit switch to be arranged on a threaded rod each, so as to be infinitely slidable by rotation of the threaded rod in order to adjust travel. In this way a constructively particularly simple but nevertheless accurate setting of the end position of the pusher rod is possible.

According to a further advantageous embodiment, the housing comprises at least one longitudinal guide in which at least one feather key that is arranged on the pusher rod is slidably accommodated. This prevents rotation of the pusher rod on its longitudinal axis. Furthermore, the at least one longitudinal guide in conjunction with the at least one feather key carries out, at least in part, the function of a guide of the pusher rod.

An advantageous improvement of the invention provides for the threaded spindle to be accommodated coaxially in the pusher rod. The coaxial design of the pusher rod and of the threaded rod makes it possible for the pusher rod to be accurately guided in longitudinal direction, as well as making possible effective centric force transmission between the threaded nut accommodated on the threaded spindle and the pusher rod. Furthermore, the coaxial arrangement makes possible a compact design.

Further advantageous embodiments of the arrangement are stated in the following claims.

The following are shown in the drawing:

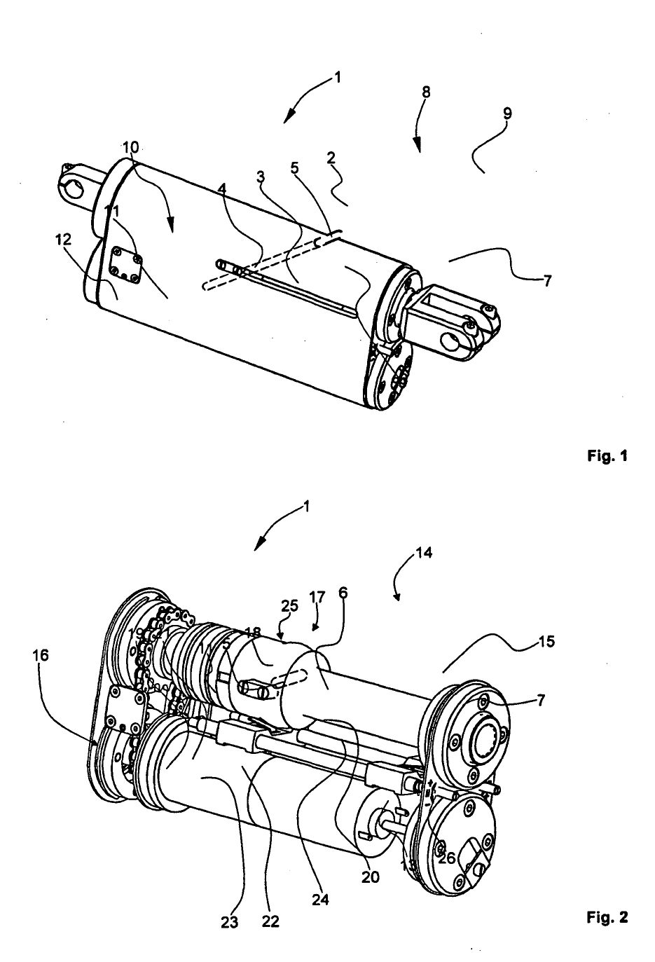

FIG. 1 a perspective overall view of the linear actuating element according to the invention;

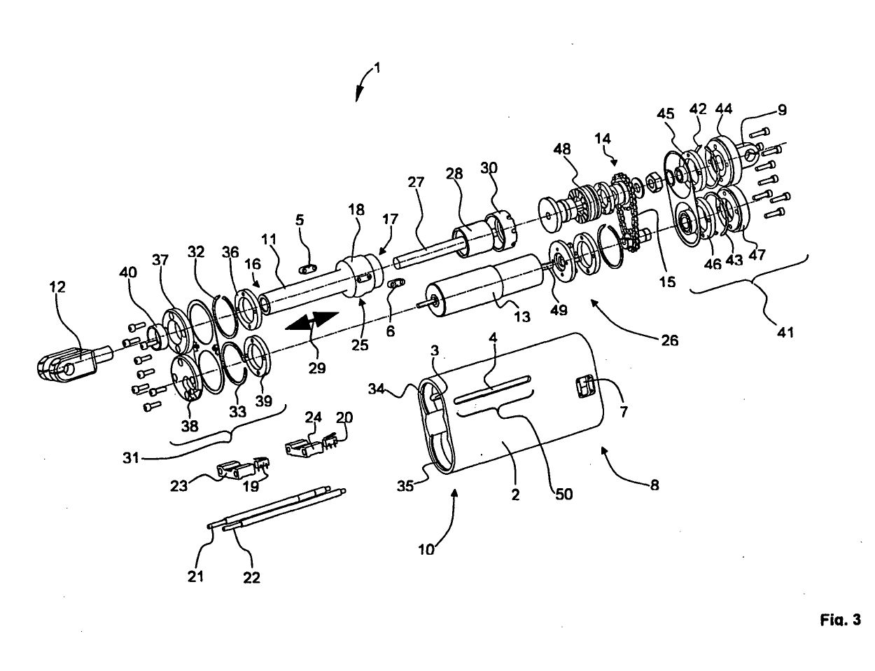

FIG. 2 a perspective view of the linear actuating element without a housing; and

FIG. 3 a detailed exploded view of the linear actuating element.

Same design elements in the drawing have the same reference characters.

FIG. 1 shows a perspective overall view of a linear actuating element 1 according to the invention.

Among other things the linear actuating element 1 comprises a housing 2 with two longitudinal guides 3, 4 in which in each case a feather key 5, 6 is accommodated so as to be slidable in longitudinal direction. In this arrangement the length of the longitudinal guides 3, 4 approximately corresponds to a travel path that can be achieved by means of the linear actuating element 1. Furthermore, a chain tensioner 7 is arranged in the housing 2. A further chain tensioner, which does not have a reference character, is placed in the rear region of the housing 2. In the region of a rear 8 of the housing 2 there is a mounting 9 for the swivellable attachment of the linear actuating element 1 to an abutment (not shown). In the region of the front 10 of the housing 2 there is a pusher rod 11 that comprises a hollow interior, with said pusher rod 11 comprising a fork head 12.

FIG. 2 shows a perspective view of the linear actuating element 1 without the housing 2.

By way of a chain drive 14 an electrical gear motor 13 drives a threaded spindle (covered up in the view shown in FIG. 2) for linear movement of the pusher rod 11. By means of the chain tensioner 7 a chain 15 of the chain drive 14 can be tensioned. For improved clarity FIG. 2 does not show the fork head 12 at a starting region 16 of the pusher rod 11. An end region 17 of the pusher rod 11 comprises a widened section 18 in the form of a hollow cylinder. The widened section 18 is in particular used to accommodate the threaded nut (also covered up in FIG. 2). On the widened section 18 the feather keys 5, 6 are attached, which in interaction with the longitudinal guides 3, 4 in particular prevent rotation of the pusher rod 11 on its longitudinal axis during actuation of the linear actuating element 1 while at the same time have a guiding function.

In the housing 2, furthermore, two limit switches 19, 20 are arranged. The limit switches 19, 20 are slidably arranged on the threaded rods 21, 22 by means of the limit switch mounting 23, 24. When the threaded rods 21, 22 are rotated, the limit switch mountings 23, 24 slide along the threaded rods 21, 22 so that in each case the positions of the limit switches 19, 20 can be adjusted independently of each other in longitudinal direction in order to adjust the travel path of the control unit 1.

By means of the control cam 25, which is arranged on the widened section 18 of the pusher rod 11, the limit switches 19, 20 are actuated in both end positions of the pusher rod 11, and travel of the linear actuating element 1 is thus delimited. In a motor mounting 26 the gear motor 13 is eccentrically accommodated so that the chain 15, by simple swivelling or slight rotation of the gear motor 13 to supplement the chain tensioner 7, can be tensioned.

It is, for example, possible to provide an absolute-value shaft encoder by means of which the position of the pusher rod 11 in longitudinal direction can be acquired at high precision by a control- and/or regulating device (not shown). Furthermore, by means of the control- and/or regulating device preferably infinitely adjustable rotary speed- and/or torque control of the gear motor 13 takes place, for example according to predetermined characteristic diagrams or the like. Instead of the chain 15, in an alternative embodiment variant of the linear actuating element 1, for example a toothed belt, a push-belt or the like can also be used for power transmission between the threaded spindle and the gear motor 13.

FIG. 3 shows a detailed exploded view of the internal design of the linear actuating element 1.

The lower part of the diagram shows the housing 2 of the linear actuating element 1 with the longitudinal guides 3, 4, the chain tensioner 7, as well as the threaded rods 21, 22 with the limit switch mountings 23, 24, as well as the limit switches 19, 20. By means of the chain tensioner 7 the chain 15 can be tensioned in addition to the option of tensioning it by means of swivelling the gear motor 13 that is eccentrically accommodated in the motor mounting 26. As a result of the control cam 25, the respective pre-set end positions of the limit switches 19, 20 are triggered by the pusher rod 11, and in this way travel of the pusher rod 11 is limited in a defined manner.

A threaded spindle 27 is rotated by means of the gear motor 13 as well as the chain drive 14. Consequently a threaded nut 28 moves parallel to the x-axis 29. The hollow pusher rod 11 is concentrically arranged on the threaded spindle 27. In order to achieve little mechanical play and thus high positioning- and repetition accuracy of the linear actuating element 1, the threaded nut 28 in conjunction with the threaded spindle 27 is designed as a so-called threaded roller screw drive. In this arrangement, with the use of two nuts that are slightly tightened in relation to each other and with the use of threaded rollers accommodated therein, very precise and almost play-free positioning of the threaded nut 28 in relation to the threaded spindle 27 is achieved so that the linear actuating element 1 makes it possible for the pusher rod 11 to move parallel to the x-axis 29 at very high mechanical precision. Furthermore, the coaxial arrangement of the threaded spindle 27 in the pusher rod 11 allows effective and essentially centric power transmission between the threaded nut 28 accommodated on the threaded spindle 27 and the pusher rod 11. Moreover, the coaxial arrangement makes possible a very compact design of the entire arrangement of the linear actuating element 1.

The threaded nut 28 is accommodated in the widened section 18 of the pusher rod 11 and is fixed therein by means of a threaded cap 30. The two feather keys 5, 6 prevent rotation of the pusher rod 11 on the x-axis 29 due to rotation of the threaded spindle 27 and at the same time contribute to guiding the pusher rod 11.

In the region of the front 10 of the housing 2 of the linear actuating element 1 there is a front bearing arrangement 31 for guiding or bearing the gear motor 13 as well as the pusher rod 11 with the fork head 12. The front bearing arrangement 31 is essentially formed with snap rings 32, 33, which can be inserted in a positive-locking manner in corresponding grooves 34, 35 in the region of two openings, arranged one on top of the other, in the front 10 of the housing 2. As a result of the flanges 36 to 39 that can be screwed together, connection to the snap rings 32, 33 inserted in the housing 2 takes place. Axial guidance of the pusher rod 11 takes place by means of a bearing 40, for example of a linear ball bearing or some other linear bearing.

A rear bearing arrangement 41 in the region of the rear 8 of the housing 2 of the linear actuating element 1 is designed analogously to the front bearing arrangement 31. The snap rings 42, 43 are again inserted in a positive-locking manner in corresponding circumferential grooves (not shown) in the region of two openings on the rear 8 of the housing 2. By means of the flanges 44 to 47 that can be screwed together, mechanical connection to the snap rings 42, 43 and thus to the housing 2 takes place.

Furthermore, in the region of the front and of the rear bearing arrangement 31, 41, flat seals that are not designated in more detail are arranged in order to seal off the housing 2. The axial forces in the direction of the x-axis 29 are essentially accommodated by an axial roller bearing 48, positioned in the region of the rear bearing arrangement 41, in the form of a thrust bearing.

A gear motor axle 49 extends essentially anti-parallel to the threaded spindle 27 so that the linear actuating element 11 overall has a very compact design, in particular a short structural length. In this context the term “anti-parallel” means that the flow of force emanating from the gear motor 13 is turned round into an opposite, anti-parallel, direction. Nevertheless the gear motor axle 49 and the threaded spindle 27 in the geometrical sense are arranged parallel in relation to each other. As a result of this the flow of force emanating from the gear motor 13 is transmitted to the threaded spindle 27 at an angle of 180°.

In this design a gear arrangement integrated in the gear motor 13 produces, for example, a reduction of 1:10, with the chain drive 14 providing an additional reduction of, for example, 1:2, while between the threaded spindle 27 and the threaded nut 28 there is, for example, a reduction of 1:5, so that the total mechanical reduction ratio is 1:100. Due to the very considerable reduction, it is possible to achieve very substantial forces with the linear actuating element 1 according to the invention. Due to the use of a threaded spindle drive, comprising the threaded spindle 27 and the threaded nut 28, at the same time extremely good positioning accuracy, i.e. in particular high positioning- and repetition accuracy of the linear movement of the pusher rod 11 parallel to the x-axis 29 is achieved. Furthermore, should the gear motor fail, the linear actuating element 1 is self-locking so that in this case forces acting on the pusher rod 11 cannot cause any undefined readjustment.

By means of the linear actuating element 1 according to the invention, absolute positioning accuracy of the pusher rod 11 parallel to the x-axis 29 of less than 0.01 mm at a travel distance of 50 mm to 100 mm can be achieved. In this arrangement mechanical positioning forces of up to 10,000 Newton can be exerted. With a corresponding design of the threaded spindle 27 and the threaded nut 28, travel speeds of 1 cm to 10 cm per minute can be achieved. The above-mentioned characteristic values remain safely reproducible along the entire travel path up to a total number of approximately one million traversing procedures, so that the linear actuating element 1 according to the invention is in particular suited as a final control element for remotely-controllable components of wind tunnel models or the like.

### LIST OF REFERENCE CHARACTERS

1 Linear actuating element
2 Housing
3 Longitudinal guide
4 Longitudinal guide
5 Feather key
6 Feather key
7 Chain tensioner
8 Rear
9 Mounting (housing of linear actuating element)
10 Front
11 Pusher rod
12 Fork head
13 Gear motor
14 Chain drive
15 Chain
16 Starting region (pusher rod)
17 End region (pusher rod)
18 Widened section
19 Limit switch
20 Limit switch
21 Threaded rod
22 Threaded rod
23 Limit switch mounting
24 Limit switch mounting
25 Control cam
26 Motor mounting (gear motor)
27 Threaded spindle
28 Threaded nut
29 X-axis
30 Threaded cap
31 Front bearing arrangement
32 Snap ring
33 Snap ring
34 Groove
35 Groove
36 Flange
37 Flange
38 Flange
39 Flange
40 Bearing
41 Rear bearing arrangement
42 Snap ring
43 Snap ring
44 Flange
45 Flange
46 Flange
47 Flange
48 Axial roller bearing
49 Gear motor axle
50 Travel path

1. A linear actuating element, for the remote control of adjustable components on wind tunnel models, comprising:
a housing, and
a gear motor for driving a threaded spindle,
wherein on the threaded spindle a threaded nut for moving a pusher rod is arranged,
wherein the threaded spindle is connected to the gear motor by a chain drive, and
wherein the threaded spindle and a gear motor axle are arranged so as to be substantially anti-parallel.

2. The linear actuating element of claim 1, wherein the gear motor is eccentrically accommodated for tensioning a chain of the chain drive.

3. The linear actuating element of claim 1, wherein the chain of the chain drive can be tensioned by at least one chain tensioner.

4. The linear actuating element of claim 1, wherein there are two limit switches for limiting travel path of the pusher rod, wherein the limit switches can be actuated by a control cam arranged in the region of the pusher rod.

5. The linear actuating element of claim 1, wherein the limit switch is arranged on a threaded rod each, so as to be infinitely slidable by rotation of the threaded rod in order to adjust travel path.

6. The linear actuating element of claim 1, wherein the housing comprises at least one longitudinal guide in which at least one feather key that is arranged on the pusher rod is slidably accommodated.

7. The linear actuating element of claim 1, wherein the threaded spindle is accommodated coaxially in the pusher rod.

8. The linear actuating element of claim 1, wherein the housing comprises a front bearing arrangement and a rear bearing arrangement.

9. The linear actuating element of claim 1, wherein the pusher rod and the threaded spindle in the region of the front bearing arrangement are accommodated in a linear bearing.

10. The linear actuating element of claim 1, wherein the gear motor can be controlled by at least one of a control device and regulating device.
